(19) United States
(12) Patent Application Publication
(10) Pub. No.: US 2023/0306509 A1
(43) Pub. Date: Sep. 28, 2023

(54) METHODS AND SYSTEMS FOR PRECIOUS METAL RESERVE MANAGEMENT FOR PRECIOUS METAL BACKED DIGITAL ASSETS

(71) Applicant: Meld Gold Pty Ltd, Hamilton (AU)

(72) Inventor: Michael Cotton, Hamilton (AU)

(73) Assignee: Meld Gold Pty Ltd, Hamilton (AU)

(21) Appl. No.: 18/020,126

(22) PCT Filed: Aug. 6, 2021
(86) PCT No.: PCT/AU2021/050861

§ 371 Date: Feb. 7, 2023

(30) Foreign Application Priority Data
Aug. 7, 2020 (AU) 2020902790

(51) Int. Cl. G06Q 40/04; G06Q 40/06

(52) U.S. Cl. CPC G06Q 40/04; G06Q 40/06

(57) ABSTRACT

Some embodiments relate to systems, stored computer-readable program instruction and methods for precious metal reserve management in a precious metal digital asset trading network implemented by a precious metal reserve management server. An example method includes: determining by the reserve management server a total digital precious metal value corresponding to issued precious metal digital assets in the precious metal digital asset trading network; determining by the reserve management server, a total reserve precious metal value based on reserve precious metal inventory data, wherein the precious metal inventory data relates to precious metal inventory stored in one or more physical locations; and generating by the reserve management server, a first transaction signal to purchase precious metal in response to the total reserve precious metal value being less than the total digital precious metal value.

### TECHNICAL FIELD

Embodiments relate to methods and systems for managing precious metal reserves for precious metal backed digital assets. In particular, embodiments relate to methods and systems for managing precious metal reserves across several precious metal trading, processing, and storage locations to provide stable backing for a precious metal backed digital asset.

### BACKGROUND

Fiat money issued by governments derives its value from the stability of the government backing the currency and the conditions of the economy where the fiat money is used. Until the early 1930s major economies such as the USA, the UK operated a monetary system incorporating a gold standard. The gold standard comprised a direct relationship between the value of the currency and gold. The gold standard served as a tool for managing the risks of inflation or deflation and provided stability in the value of a currency backed by gold. Gold was a preferred basis for a standard due to its rarity, durability, divisibility, fungibility and ease of identification.

Cryptocurrencies such as Bitcoin or Ethereum derive their value from an artificial scarcity or a controlled supply of the cryptocurrencies created by the specific cryptographic protocols that control the cryptocurrency networks where they subsist. Unlike the gold standard, the value of conventional cryptocurrencies is not tightly associated with any real-world objects.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each claim of this application.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### SUMMARY

Some embodiments relate to a method for precious metal reserve management in a precious metal digital asset trading network implemented by a precious metal reserve management server, the method comprising: determining by the reserve management server a total digital precious metal value corresponding to issued precious metal digital assets in the precious metal digital asset trading network; determining by the reserve management server, a total reserve precious metal value based on reserve precious metal inventory data, wherein the precious metal inventory data relates to precious metal inventory stored in one or more physical locations; generating by the reserve management server, a first transaction signal to purchase precious metal in response to the total reserve precious metal value being less than the total digital precious metal value; analysing by the reserve management server, precious metal commodity pricing data to determine a commodity pricing change projection over a subsequent precious metal reserve rebalancing period, in response to the total reserve precious metal value being greater than or equal to the total digital precious metal value; generating by the reserve management server, a second transaction signal to hold existing precious metal reserve inventory or purchase additional precious metal reserve inventory, in response to the determined commodity pricing change projection being greater than a first commodity pricing change threshold; generating by the reserve management server, a third transaction signal to hold existing precious metal reserve inventory or sell a part of precious metal reserve inventory, in response to the determined commodity pricing change projection being less than a second commodity pricing change threshold; determining by the reserve management server a precious metal digital asset transaction trend based on a precious metal digital asset transaction data in response to the commodity pricing change projection being less than the first commodity pricing change threshold and greater than second commodity pricing change threshold; and generating by the reserve management server a further transaction signal based on the precious metal digital asset transaction trend and a precious metal inventory float value; wherein the precious metal reserve management is performed at a defined rebalancing frequency.

In some embodiments, the commodity pricing change projection comprises determining one or more repeating commodity price movement patterns based on the precious metal commodity pricing data.

In some embodiments, determining the commodity pricing change projection further comprises analysing a subset of the precious metal commodity pricing data to determine a fit probability of the one or more repeating commodity price movement patterns.

In some embodiments, determining the commodity pricing change projection comprises determining a market movement pressure metric based on precious metal buy and sell order data comprised in the precious metal commodity pricing data.

In some embodiments, determining by the reserve management server the precious metal digital asset transaction trend comprises determining an average precious metal digital asset transaction level over one or more recent transaction periods based on the precious metal digital asset transaction data.

In some embodiments, determining the average precious metal digital asset transaction level comprises excluding from the precious metal digital asset transaction data transactions larger than an outlier transaction threshold.

In some embodiments, determining by the reserve management server the precious metal digital asset transaction trend comprises analysing one or more precious metal digital asset transaction data relating to unsettled precious metal digital asset transactions.

In some embodiments, the precious metal reserve management server is configured to update the defined rebalancing frequency based on a difference between the commodity pricing change projection and an actual commodity price change over one or more previous rebalancing periods.

In some embodiments, the precious metal reserve management server is configured to update the defined rebalancing frequency based on the precious metal digital asset transaction trend and precious metal digital asset transaction data stored for one or more previous rebalancing periods.

In some embodiments, generating by the reserve management server the further transaction signal comprises: generating by the reserve management server, a fourth transaction signal to purchase precious metal in response to: the precious metal digital asset transaction trend being greater than a third threshold; and the total reserve precious metal value being less than a sum of precious metal inventory float value and total digital precious metal value.

In some embodiments, generating by the reserve management server the further transaction signal based on the precious metal digital asset transaction trend and a precious metal inventory float value comprises: determining a projected change value in the total digital precious metal value based on the determined precious metal digital asset transaction trend; generating by the reserve management server, a fifth transaction signal to sell precious metal in response to: the precious metal digital asset transaction trend being greater than a third threshold; and the total reserve precious metal value being greater than a sum of the precious metal inventory float value and the total digital precious metal value and the projected change value.

In some embodiments, generating by the reserve management server the further transaction signal based on the precious metal digital asset transaction trend and a precious metal inventory float value comprises: generating by the reserve management server, a sixth transaction signal to sell precious metal in response to: the precious metal digital asset transaction trend being less than the third threshold and greater than a fourth threshold; and the total reserve precious metal value being greater than a sum of precious metal inventory float value and total digital precious metal value.

In some embodiments, generating by the reserve management server the further transaction signal based on the precious metal digital asset transaction trend and a precious metal inventory float value comprises: determining a projected change value in the total digital precious metal value based on the determined precious metal digital asset transaction trend; generating by the reserve management server, a seventh transaction signal to hold precious metal in response to: the precious metal digital asset transaction trend being smaller than the third threshold and smaller than a fourth threshold; and the total reserve precious metal value being less than a sum of the precious metal inventory float value and the total digital precious metal value and the projected change value.

Some embodiments relate to a method for precious metal reserve management in a precious metal digital asset trading network implemented by a precious metal reserve management server, the method comprising: determining by the reserve management server a total digital precious metal value corresponding to issued precious metal digital assets in the precious metal digital asset trading network; determining by the reserve management server, a total reserve precious metal value based on reserve precious metal inventory data, wherein the precious metal inventory data relates to precious metal inventory stored in one or more physical locations; determining by the reserve management server a precious metal digital asset transaction trend based on a precious metal digital asset transaction data; generating by the reserve management server, a fourth transaction signal to purchase precious metal in response to: the precious metal digital asset transaction trend being greater than a third threshold; and the total reserve precious metal value being less than a sum of a precious metal inventory float value and total digital precious metal value.

The method of some embodiments further comprises determining a projected change value in the total digital precious metal value based on the determined precious metal digital asset transaction trend; generating by the reserve management server, a fifth transaction signal to sell precious metal in response to: the precious metal digital asset transaction trend being greater than a third threshold; and the total reserve precious metal value being greater than a sum of the precious metal inventory float value and the total digital precious metal value and the projected change value.

The method of some embodiments further comprises: generating by the reserve management server, a sixth transaction signal to sell precious metal in response to: the precious metal digital asset transaction trend being less than the third threshold and greater than a fourth threshold; and the total reserve precious metal value being greater than a sum of precious metal inventory float value and total digital precious metal value.

The method of some embodiments further comprises determining a projected change value in the total digital precious metal value based on the determined precious metal digital asset transaction trend; generating by the reserve management server, a seventh transaction signal to hold precious metal in response to: the precious metal digital asset transaction trend being less than the third threshold and less than a fourth threshold; and the total reserve precious metal value being less than a sum of the precious metal inventory float value and the total digital precious metal value and the projected change value.

Some embodiments relate to a system for precious metal reserve management in a precious metal digital asset trading network, the system comprising: at least one processor, a memory accessible to the at least one processor, the memory comprising program code which when executed by the at least one processor configures the at least one processor to: determine a total digital precious metal value corresponding to issued precious metal digital assets in the precious metal digital asset trading network; determine a total reserve precious metal value based on reserve precious metal inventory data, wherein the precious metal inventory data relates to precious metal inventory stored in one or more physical locations; generate a first transaction signal to purchase precious metal in response to the total reserve precious metal value being less than the total digital precious metal value; analyse precious metal commodity pricing data to determine a commodity pricing change projection over a subsequent precious metal reserve rebalancing period, in response to the total reserve precious metal value being greater than or equal to the total digital precious metal value; generate a second transaction signal to hold existing precious metal reserve inventory or purchase additional precious metal reserve inventory, in response to the determined commodity pricing change projection being greater than a first commodity pricing change threshold; generate a third transaction signal to hold existing precious metal reserve inventory or sell a part of precious metal reserve inventory, in response to the determined commodity pricing change projection being less than a second commodity pricing change threshold; determine a precious metal digital asset transaction trend based on a precious metal digital asset transaction data in response to the commodity pricing change projection being less than the first commodity pricing change threshold and greater than second commodity pricing change threshold; and generate a further transaction signal based on the precious metal digital asset transaction trend and a precious metal inventory float value; wherein the precious metal reserve management is performed at a defined rebalancing frequency.

In some embodiments, determining the commodity pricing change projection comprises determining one or more repeating commodity price movement patterns based on the precious metal commodity pricing data.

In some embodiments, determining the commodity pricing change projection further comprises analysing a subset of the precious metal commodity pricing data to determine a fit probability of the one or more repeating commodity price movement patterns.

In some embodiments, determining the commodity pricing change projection comprises determining a market movement pressure metric based on precious metal buy and sell order data comprised in the precious metal commodity pricing data.

In some embodiments, determining the precious metal digital asset transaction trend comprises determining an average precious metal digital asset transaction level over one or more recent transaction periods based on the precious metal digital asset transaction data.

In some embodiments, determining the average precious metal digital asset transaction level comprises excluding from the precious metal digital asset transaction data transactions larger than an outlier transaction threshold.

In some embodiments, determining the precious metal digital asset transaction trend comprises analysing one or more precious metal digital asset transaction data relating to unsettled precious metal digital asset transactions.

In some embodiments, the at least one processor is further configured to update the defined rebalancing frequency based on a difference between the commodity pricing change projection and an actual commodity price change over one or more previous rebalancing periods.

In some embodiments, the at least one processor is further configured to update the defined rebalancing frequency based on the precious metal digital asset transaction trend and an precious metal digital asset transaction data stored for one or more previous rebalancing periods.

In some embodiments, generating the further transaction signal comprises: generating by the at least one processor, a fourth transaction signal to purchase precious metal in response to: the precious metal digital asset transaction trend being greater than a third threshold; and the total reserve precious metal value being less than a sum of precious metal inventory float value and total digital precious metal value.

In some embodiments, generating the further transaction signal comprises: determining by the at least one processor, a projected change value in the total digital precious metal value based on the determined precious metal digital asset transaction trend; generating by the at least one processor, a fifth transaction signal to sell precious metal in response to: the precious metal digital asset transaction trend being greater than a third threshold; and the total reserve precious metal value being greater than a sum of the precious metal inventory float value and the total digital precious metal value and the projected change value.

In some embodiments, generating the further transaction signal comprises: generating by the at least one processor, a sixth transaction signal to sell precious metal in response to: the precious metal digital asset transaction trend being less than the third threshold and greater than a fourth threshold; and the total reserve precious metal value being greater than a sum of precious metal inventory float value and total digital precious metal value.

In some embodiments, generating the further transaction signal comprises: determining by the at least one processor a projected change value in the total digital precious metal value based on the determined precious metal digital asset transaction trend; generating, by the at least one processor, a seventh transaction signal to hold precious metal in response to: the precious metal digital asset transaction trend being smaller than the third threshold and smaller than a fourth threshold; and the total reserve precious metal value being less than a sum of the precious metal inventory float value and the total digital precious metal value and the projected change value.

Some embodiments relate to a system for precious metal reserve management in a precious metal digital asset trading network, the system comprising: at least one processor, a memory accessible to the at least one processor, the memory comprising program code which when executed by the at least one processor configures the at least one processor to: determine a total digital precious metal value corresponding to issued precious metal digital assets in the precious metal digital asset trading network; determine a total reserve precious metal value based on reserve precious metal inventory data, wherein the precious metal inventory data relates to precious metal inventory stored in one or more physical locations; determine a precious metal digital asset transaction trend based on a precious metal digital asset transaction data; generate a fourth transaction signal to purchase precious metal in response to: the precious metal digital asset transaction trend being greater than a third threshold; and the total reserve precious metal value being less than a sum of a precious metal inventory float value and total digital precious metal value.

In some embodiments, the at least one processor is further configured to: determine a projected change value in the total digital precious metal value based on the determined precious metal digital asset transaction trend; generate by the reserve management server, a fifth transaction signal to sell precious metal in response to: the precious metal digital asset transaction trend being greater than a third threshold; and the total reserve precious metal value being greater than a sum of the precious metal inventory float value and the total digital precious metal value and the projected change value.

In some embodiments, the at least one processor is further configured to: generate a sixth transaction signal to sell precious metal in response to: the precious metal digital asset transaction trend being less than the third threshold and greater than a fourth threshold; and the total reserve precious metal value being greater than a sum of precious metal inventory float value and total digital precious metal value.

In some embodiments, the at least one processor is further configured to: determine a projected change value in the total digital precious metal value based on the determined precious metal digital asset transaction trend; generate a seventh transaction signal to hold precious metal in response to: the precious metal digital asset transaction trend being less than the third threshold and less than a fourth threshold; and the total reserve precious metal value being less than a sum of the precious metal inventory float value and the total digital precious metal value and the projected change value.

Some embodiments relate to computer readable storage media comprising computer-readable instructions that when executed by the one or more processing units performs one or more of the methods described herein.

### BRIEF DESCRIPTION OF DRAWINGS

FIG. 1 is a block diagram of a precious metal reserve management system according to some embodiments;

FIG. 2 is a schematic diagram of a part of the precious metal digital asset trading network according to some embodiments;

FIG. 3 is a flowchart of part of a method of precious metal reserve management according to some embodiments;

FIG. 4 is a flowchart of part of a method of precious metal reserve management according to some embodiments;

FIG. 5 is a screenshot of a user interface of a precious metal inventory management application according to some embodiments; and

FIG. 6 illustrates a computer system according to some embodiments.

### DESCRIPTION OF EMBODIMENTS

The embodiments relate to methods and systems for precious metal reserve management for precious metal backed digital assets. The precious metal backed digital assets may be referred to as “stablecoins.” Precious metal backed digital assets according to some embodiments are digital assets issued or created within a Blockchain network or a distributed ledger database. Corresponding to each precious metal backed digital asset is a mass of a precious metal reserve securely stored in the real world in one or more vaults or one or more precious metal or bullion storage locations.

Embodiments also relate to a precious metal digital asset trading network wherein several participants, such as individuals, precious metal assayers and/or refiners, precious metal vault operators or precious metal commodity traders can trade the precious metal backed digital assets with each other. The precious metal backed digital assets may be redeemed in kind or exchanged for fiat currency or one or more cryptocurrencies through the precious metal digital asset trading network. Through the trading activity within the precious metal digital asset trading network, new precious metal digital assets may be created or previously created precious metal digital assets may be redeemed. The creation or redemption of precious metal digital assets necessitates corresponding changes to the total precious metal reserve backing the precious metal digital asset. As transactions occur through the digital asset trading network, the embodiments provide systems and computer implemented methods to manage the corresponding precious metal reserves.

While transactions through the precious metal digital asset trading network may occur on a real-time or near real-time basis, the management operations for rebalancing the corresponding precious metal reserves may occur responsive to the transactions of the precious metal digital assets. In some embodiments, it may be necessary to maintain a particular coverage ratio, i.e. a ratio between the precious metal reserves and the issued precious metal digital asset to meet contractual or regulatory requirements. The systems and methods according to the embodiments enable automation of the steps necessary to manage the precious metal reserves corresponding to the issued precious metal digital assets. Some embodiments also automate the rebalancing of the precious metal reserves in a manner that is responsive to changes or trends in commodity prices of the relevant precious metal. Some embodiments also automate the rebalancing of the precious metal reserves in a manner that is responsive to changes or trends in the issuance rate or redemption rate of the precision metal digital assets.

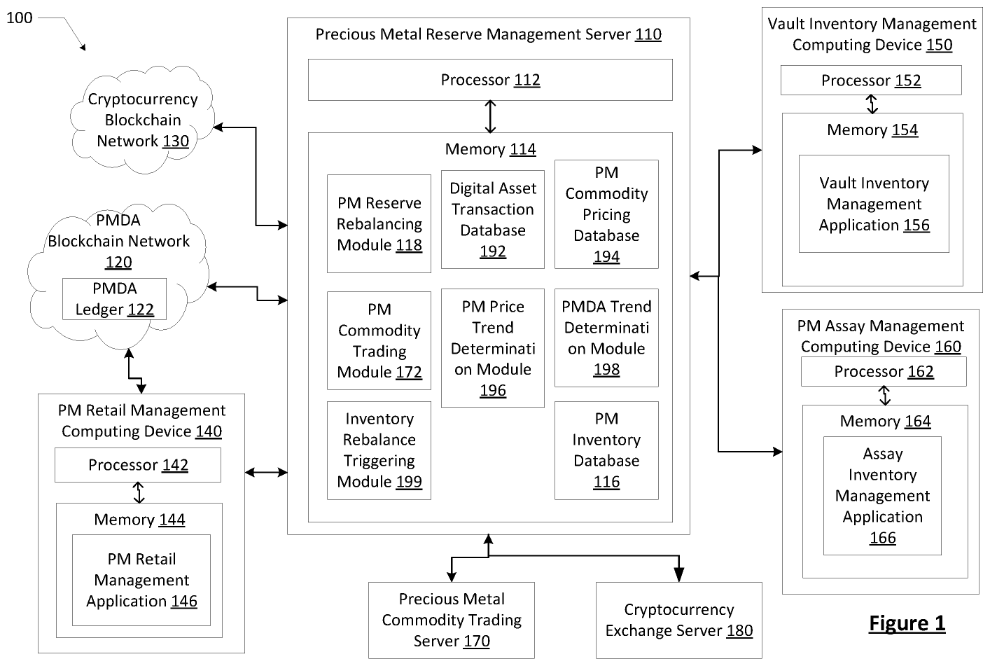

FIG. 1 illustrates a precious metal reserve management system 100 according to some embodiments. The precious metal reserve management system 100 comprises a precious metal (PM) reserve management server 110 configured to process information regarding transactions within the precious metal digital asset trading network and generate signals to manage the precious metal reserve within the precious metal digital asset trading network. The PM reserve management server 110 comprises one or more processors 112 in communication with a memory 114. Within memory 114 are stored various program code modules that are executable by the processor 112 to perform the various computing operations of the PM reserve management server 110. In the context of the present disclosure, the term “signal” is to be understood to include a software or hardware instruction generated and transmitted from one software or hardware component to another software or hardware component within the computing systems and architecture described herein.

In some embodiments, the precious metal reserve management server 110 may be a part of a Precious Metal Digital Asset (PMDA) Blockchain network 120. In some embodiments, the precious metal reserve management server 110 may have access to a PMDA ledger 122 of the PMDA Blockchain network 120. The PMDA Blockchain network 120 is a network of computer systems or computing nodes that implement a predetermined standard or protocol to manage the PMDA ledger 122 recording the creation, allocation and redemption of PMDAs.

The PMDA ledger 122 comprises block records that are linked together and that adhere to a predetermined standard or protocol. Each block record is a data structure that contains a payload and a link to a previous block record. The payload of a block record may comprise transaction information in relation to PMDAs. The transaction information may comprise, information regarding the creation and allocation of PMDAs to accounts or wallets held by participants in the PMDA trading network. Each account or wallet of the PMDA Blockchain network may be held by an entity or an individual in the real world. The holder of the account or wallet may have a private key or a password corresponding to the account to enable the holder to perform transactions securely using the precious metal digital asset black chain network 120. By analysing the series of block records held in the PMDA ledger 122, the amount of PMDAs owned by each account participating in the PMDA trading network may be determined. New transactions within the PMDA trading network may be included in new block records chained to the last block record incorporated in the PMDA ledger 122. In some embodiments, the PMDA Blockchain network 120 may be implemented using the Algorand blockchain protocol.

The PM reserve management server 110 may also be configured to communicate with one or more Cryptocurrency Blockchain networks 130 to perform transactions over the one or more Cryptocurrency Blockchain networks 130. The PM reserve management server 110 is also configured to communicate with one or more PM retail management computing devices 140. The PM retail management computing device 140 comprises at least one processor 142 in communication with a memory 144. The memory 144 comprises program code modules to implement a PM retail management application 146. The PM retail management application 146 allows performing PMDA transactions on behalf of retail customers or management of PM inventory data associated with a retail store location. The PM inventory data associated with retail store locations may be stored in a PM inventory database 116 in the memory 114 of the PM reserve management server 110.

In some embodiments, the PM reserve management server 110 may be configured to communicate with one or more vault inventory management computing device 150. The vault inventory management computing device 150 comprises a processor 152 in communication with a memory 154. The memory 154 stores program code to implement a vault inventory management application 156. The vault inventory management application 156 enables the tracking or management of inventory data stored in the PM inventory database 116 relating to precious metals stored in a corresponding vault. With the movement of precious metal into or out of a vault, the vault inventory management application 156 may allow a vault owner or operator to reflect the PM inventory changes in the PM inventory database 116.

In some embodiments, the PM reserve management server 110 may be configured to communicate with one or more PM assay management computing devices 160. The PM assay management computing device 160 comprises a processor 162 in communication with a memory 164. The memory 164 stores program code to implement an assay inventory management application 166. The assay inventory management application 166 enables the tracking or management of inventory data stored in the PM inventory database 116 relating to precious metals being assayed and/or refined or otherwise processed in a corresponding assay facility or refinery. Following the assaying, refining or other processing of precious metals, the assay inventory management application 156 may allow an assay facility or refinery owner or operator to reflect the PM inventory changes in the PM inventory database 116.

In some embodiments, the PM reserve management server 110 may also be configured to communicate with one or more PM commodity trading servers 170. The PM commodity trading server 170 may provide a PM trading Application Programming Interface (API) enabling programmatic purchase or the sale of precious metals in real-time or near real-time.

In some embodiments, the PM reserve management server 110 may also be configured to communicate with one or more cryptocurrency exchange servers 180. The cryptocurrency exchange server 180 may provide a cryptocurrency trading API enabling a service to programmatically buy or sell cryptocurrencies using fiat currency in real-time or near real-time. Cryptocurrency trading API service providers include Binance, Coinbase, Gemini, Robinhood, and Voyager, for example.

The memory 114 of the PM reserve management server 110 comprises program code to implement one or more modules to manage the PM reserves within the PM trading network. A PM reserve rebalancing module 118 comprises computational logic to determine or forecast signals to either buy, hold or sell PM reserve inventory in response to PMDA transaction or PM commodity transactions across the PM trading network. A digital asset transaction database 192 comprises transactional data regarding the creation, transfer or redemption of PMDAs. The transactional data regarding the creation, transfer or redemption of PMDAs may be obtained from the PMDA ledger 122 in the PMDA Blockchain network 120. A PM commodity pricing database 194 comprises historical PM commodity pricing data obtained from one or more PM commodity trading markets. A PM Commodity Trading module 172 comprises program code and computational logic to execute one or more PM commodity transactions through the PM commodity trading server 170. A PM commodity price trend determination module 196 comprises program code to analyse the data in the PM commodity pricing database 194 and generate a trend or prediction or projection of a change in a PM commodity price. The commodity price change projection may be over a defined reserve rebalancing period of 1, 2, 3, 4, 5, 6, 7, 8, 9, or 10 minutes, 20 minutes, 30 minutes, for example. The defined reserve rebalancing period may be dynamically redefined, as described further herein.

The memory 114 of the PM reserve management server 110 comprises an inventory rebalance triggering module 199 that generates a signal to initiate a rebalancing on the PM reserve inventory with the PMDAs. Since PMDAs may be created based on demand in the PMDA trading network and similarly PM reserve inventory 250 may also vary with the flow of precious metals in and out of the PM reserve inventory, there will be a need to dynamically and responsively rebalance the PM reserve inventory 250 against the PMDAs issued.

The inventory rebalance triggering module 199 has access to the digital asset transaction database 192 and the PM inventory database 116 to analyse past rebalancing actions undertaken by the PM reserve rebalancing module 118. By analysing the past rebalancing actions undertaken by the PM reserve rebalancing module 118, the inventory rebalance triggering module 199 is configured to identify an optimal rebalancing frequency or an optimal rebalancing period to minimise transaction costs while meeting the reserve requirements. In some embodiments, the inventory rebalance triggering module 199 may identify a difference between the PM reserve inventory 250 and the PMDAs. If the identified difference exceeds a defined rebalance threshold, then the inventory rebalance triggering module 199 may generate a trigger to initiate a PM inventory rebalancing transaction before the next scheduled rebalancing.

A PMDA trend determination module 198 provided in memory 114 of the PM reserve management server 110 comprises program code embodying computational logic to analyse data in the PMDA transaction database 192 and determine a trend or prediction or projection regarding the demand for PMDAs over the defined reserve rebalancing period.

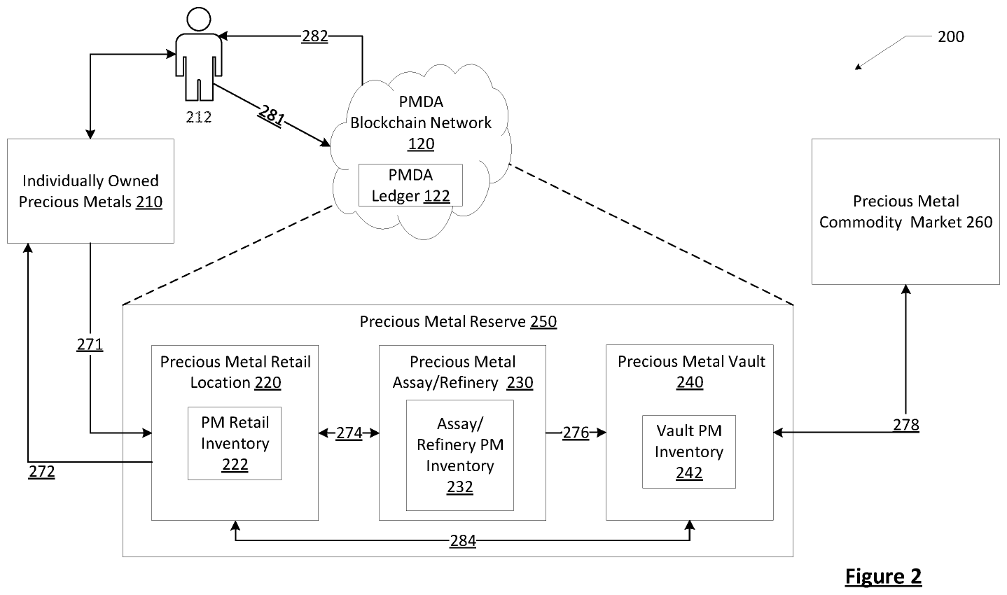

FIG. 2 illustrates a schematic diagram of part of the precious metal digital asset trading network including the physical locations where the reserve precious metal may exist in the trading network and the directions in which the precious metal may move or be transacted within the precious metal trading network. Component 210 corresponds to precious metals owned by an individual 212. Since the precious metal component 210 is owned by individuals it does not form part of a precious metal reserve 250 that backs the PMDAs issued through the PMDA Blockchain network 120. Individual 212 may sell precious metals owned by them (flow 271 in FIG. 2) to a precious metal retail outlet 220 in exchange for a corresponding amount of PMDAs (flow 282). Individual 212 may also redeem precious metals from a precious metal retail outlet 220 (flow 272) in exchange for depositing or returning a corresponding amount of PMDAs to a market maker in the PMDA Blockchain network 120 (flow 281). Once precious metals are received by the precious metal retail outlet 220, the PM retail inventory 222 is accordingly updated and the received precious metal forms part of the PM reserve backing the PMDAs. Similarly, as PMDAs are redeemed (flow 281), PM inventory leaves PM retail inventory 222 (flow 272) and ceases to form part of the precious metal reserve 250.

PM retail inventory 222 may be moved to and from one or more PM refinery 230 (flow 274). The PM retail inventory 222 may be moved to and from one or more PM vaults 240 (flow 284). Similarly, refinery PM inventory 232 may move to a vault PM inventory 242 (flow 276) for long term secure storage. Depending on the need for PM retail inventory 222 at a particular retail location, Vault PM inventory 242 or refinery PM inventory 232 may be moved to a particular PM retail outlet to meet the anticipated needs while keeping most of the PM reserve 250 as secure as possible. Precious metal inventory may also flow in and out of the PM reserve 250 by transactions with one or more PM commodity market 260 (flow 278). For example, if there is a need to increase PM reserve 250 to back newly issued PMDAs, then a corresponding amount of precious metal may be purchased from the PM Commodity market 260. Similarly, if there is a need to liquidate part of the PM reserve 250 in response to the liquidation of PMDAs, then a part of the PM reserve may be sold through the PM commodity market 260 to minimise the holding of unnecessary PM reserve 250. The PM reserve management server 110 takes the necessary actions to maintain sufficient PM reserve 250 at each rebalancing point and ensure sufficient liquidity of the precious metal to meet demand at various PM retail outlets 220.

As the PM inventory moves or transitions through the flows 271, 272, 274, 276, 284 and 278, the PM inventory database 116 may be updated to accurately reflect the changes or flows in the PM inventory and to maintain an accurate record of the location and quantum of PM assets. The PM inventory database 116 may be updated through operations using the vault inventory management application 156, or the assay inventory management application 166, or the PM retail management application.

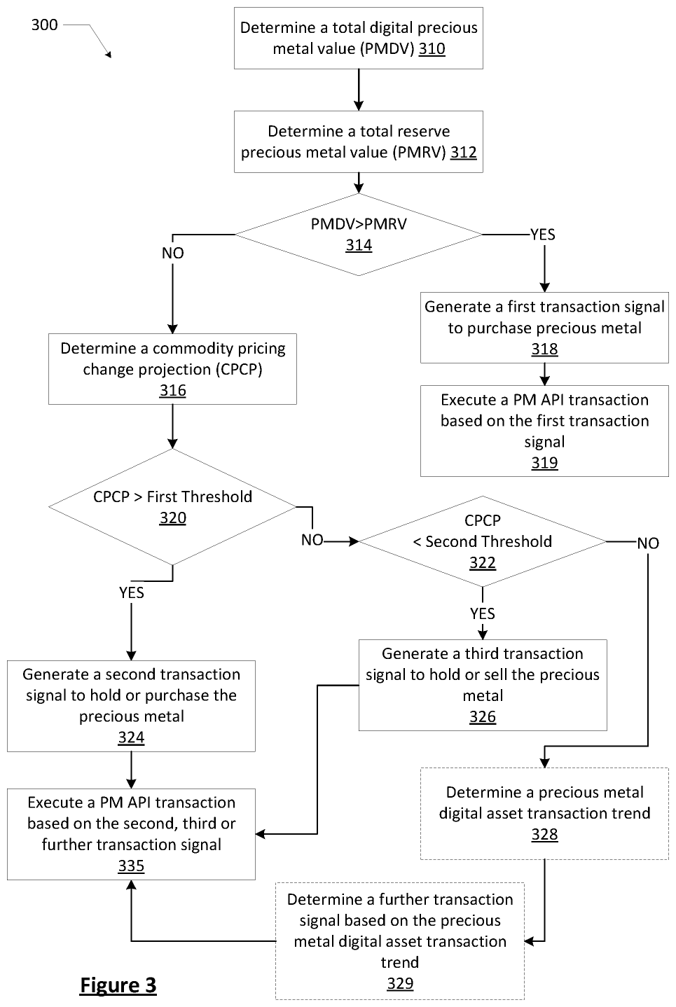

FIG. 3 illustrates a flowchart of a method 300 performed by the precious metal reserve management server 110 according to some embodiments. One goal of the precious metal reserve management server 110 is to ensure that the precious metal reserve 250 is at least equal to the amount of precious metal associated with PMDAs in circulation within the PMDA Blockchain network 120. Another goal of the precious metal reserve management server 110 is to adaptively respond to anticipated changes in precious metal commodity prices to manage the economic costs of providing the precious metal reserve 250 while ensuring ample liquidity in the precious metal trading network. Given substantial costs are associated with the ownership and storage of precious metals, the precious metal reserve management server 110 is configured to perform transactions, or generate signals to optimise the cost of ownership and storage of the precious metal reserve 250.

At step 310, the PM reserve rebalancing module 118 determines a total digital precious metal value (PMDV) associated will all the PMDAs in circulation in the PMDA Blockchain network 120. Since each PMDA corresponds to a specific quantum (e.g. weight, such as 1 gram) of precious metal, calculating the total number of PMDAs that were issued and remain outstanding provides a benchmark for the requirements for the precious metal reserves 250 to back up the PMDAs. The PM reserve rebalancing module 118 may determine the PMDV based on the information in the digital asset transaction database 192. The digital asset transaction database 192 comprises data regarding all transactions performed over the PMDA Blockchain network 120, including issuing of PMDAs, transfer of PMDAs and redemption or liquidation of PMDAs, for example.

At step 312, the PM reserve rebalancing module 118 determines a total reserve precious metal value (PMRV) associated with all the physical precious metals reserve 250. The determination of PMRV includes consideration of any changes to the PM retail inventory 222, PM refinery inventory 232, and PM vault inventory 242. The PM inventory database 116 may comprise data regarding the PM reserve inventory 250 that may be continually updated as precious metals move among the various storage locations or inventories through transactions.

At step 314, the PM reserve rebalancing module 118 performs a comparison between the determined PMRV and the PMDV. If the PMDV is greater than the PMRV, then this indicates a shortfall in the reserve. To address this shortfall in PM reserve inventory 250, the PM reserve rebalancing module 118 generates a first transaction signal to buy the difference between the PMDV and the PMRV to address the shortfall. The first transaction signal may be sent to the PM commodity trading module 172 to execute one or more trades to perform a transaction based on the first transaction signal. The transaction signal comprises data regarding the amount of PM reserve to be purchased. At step 319, the PM reserve rebalancing module 118 executes a PM API transaction using the PM commodity trading API 172 based on the generated first transaction signal to rebalance the PM reserve inventory 250 with the outstanding or issued PMDAs.

If at step 314, the PM reserve rebalancing module 118 determines that the PMRV exceeds the PMDV, then the PM reserve rebalancing module 118 executes the PM commodity price trend determination module 196 to analyse data in the PM commodity pricing database 194 and determine a PM commodity price change projection (CPCP). The PM commodity pricing database 194 comprises historical data regarding commodity prices obtained from public commodity markets. The PM commodity price trend determination module 196 may incorporate program code embodying trend analysis data processing computation models. The trend analysis data processing computation models may determine a trend of the precious metal commodity price based on one more technical indicators such as long term moving average of the commodity price, a short term moving average of the commodity price, one or more momentum indicators of the commodity price such as a relative strength index or a moving average convergence divergence indicator.

In some embodiments, the trend analysis data processing computation models may determine a trend of the precious metal commodity price based on a price pattern analysis. Price patterns may comprise a recognisable configuration of price movement that is identified using a series of trend lines and/or curves. The recognisable configuration of price movement may include a pennant price pattern, a flag price pattern, a wedge price pattern, a triangle price pattern, a cup and handle price pattern, and/or a head and shoulders price pattern, for example. On recognising one of the preconfigured price patterns, the PM commodity price trend determination module 196 may determine the commodity price change projection based on the recognised pattern and changes in the PM commodity price within a predetermined window that correlate to at least part of the recognised pattern. The correlation between the PM commodity price within the predetermined window and the recognised pattern may be represented in the form of a pattern fit probability indicating to what extent the recognised pattern is observable in the PM commodity price data.

In some embodiments, the PM commodity pricing database 194 may comprise data regarding unsettled or open precious metal commodity transactions in one or more precious commodity markets. The data regarding unsettled or open precious metal commodity transaction may be used by the PM commodity price trend determination module 196 to estimate a market pressure metric. Based on the market pressure metric, the PM commodity price trend determination module 196 may validate the determined PM commodity price change projection. The PM commodity price change projection may be in the form of an expected percentage change (increase or decrease) in the PM commodity over a subsequent rebalancing period. In some embodiments, projections obtained from separate analysis may be aggregated to obtain an aggregate projection that is more accurate than an individual projection. If insufficient data is available for a specific basis for projection, for example data regarding unsettled or open precious metal commodity transactions is not available or insufficient, then the projection based on unsettled or open precious metal commodity transactions may not be considered by the PM commodity price trend determination module 196. In some embodiments, the PM commodity price change projection may be represented as a percentage figure indicating a projected change in price over a defined future period. In some embodiments, the PM commodity price change projection may be represented as a ratio or a multiplier figure indicating a projected change in price over a defined future period.

At step 320, the PM reserve rebalancing module 118 compares the determined commodity price change projection to a first positive threshold. If the commodity price change projection is found to be greater than the first threshold, then the PM reserve rebalancing module 118 generates a second transaction signal to hold or purchase the precious metal at step 324. The second transaction signal may comprise data regarding the quantum of precious metal to be purchased. The second transaction signal may be sent to the PM commodity trading module 172 to execute one or more trades to perform a transaction based on the second transaction signal. With the anticipated increase in the PM commodity price, holding or purchasing more PM commodity would be a sound economic decision. At step 335, the PM reserve rebalancing module 118 may invoke the PM commodity trading API 172 to execute a PM commodity trade based on the second transaction signal.

If at step 320, the PM reserve rebalancing module 118 determines that the commodity price change projection is less than the first positive threshold, then at step 322 the PM reserve rebalancing module 118 determines whether the commodity price change projection is less than a second threshold. The second threshold may be a negative threshold or a threshold lower than the first threshold. If the commodity price change projection is determined to be less than a second threshold, then the PM reserve rebalancing module 118 generates a third transaction signal to hold or sell the precious metal at step 326. The third transaction signal may be sent to the PM commodity trading module 172 to execute one or more trades to fulfil perform a transaction based on the third transaction signal. Transaction based on the generated third transaction signal may be executed at step 335 by the PM reserve rebalancing module 118.

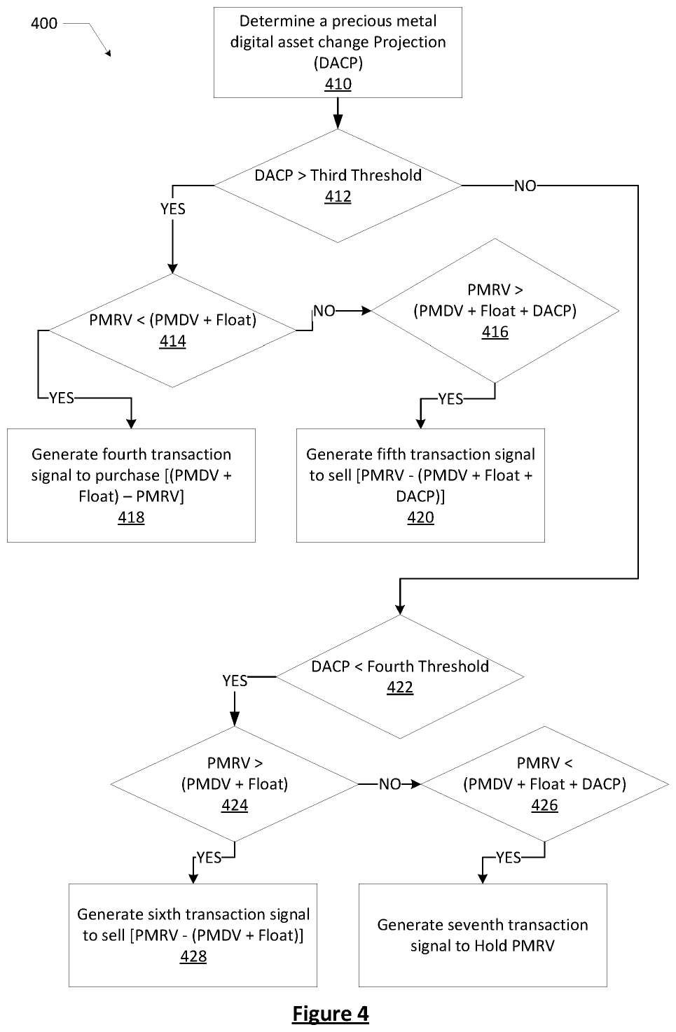

If at step 322 the PM reserve rebalancing module 118 determines that the commodity price change projection is greater than a second negative threshold, then a precious metal digital asset transaction trend may be determined by the PMDA Trend determination module 198 at step 328. Based on the determined PMDA transaction trend, the PM reserve rebalancing module 118 may determine a further transaction signal at 329. The further transaction signal may be executed at step 335. Flowchart 400 of FIG. 4 illustrates in detail steps 328 and 329 of flowchart 300. In some embodiments, steps 328 and 329 may be optional steps. In some embodiments, steps 328 and 329 may be performed independently of the rest of the steps of the flowchart of FIG. 3.

FIG. 4 illustrates a flowchart of a method 400 of generating further transaction signals based on the precious metal digital asset transaction trend determined at step 328. At step 410, a precious metal digital asset change projection (DACP) over a subsequent rebalancing period is determined by the PMDA trend determination module 198. In some embodiments, a projected change value in the issued precious metal digital assets may be determined based on the determined precious metal digital asset change projection (DACP). The precious metal digital asset change projection may be based on an average precious metal digital asset transaction level over one or more recent transaction periods based on the data in the digital asset transaction database 192. The determination of average precious metal digital asset transaction level may exclude from the precious metal digital asset transaction data transactions larger than an outlier transaction threshold. An outlier transaction, such as a very large transaction, may not occur repeatedly and accordingly, such transactions may be excluded for the purpose of determination of the average precious metal digital asset transaction level. In some embodiments, determining the precious metal digital asset transaction trend may comprise analysing precious metal digital asset transaction data relating to unsettled precious metal digital asset transactions. The DACP may be represented as a predicted percentage change and it may be a positive percentage change or a negative percentage change. In some embodiments, the DACP may be represented as a ratio or a multiplier indicating a predicted increase or a decrease in the number or amount of PMDAs over a subsequent rebalancing period.

At step 412, the PM reserve rebalancing module 118 determines whether the determined the precious metal digital asset change projection (DACP) is above a third threshold. If the precious metal digital asset change projection (DACP) is above a third threshold, then at step 414 the PM reserve rebalancing module 118 determines whether the precious metal reserve value (PMRV) is less than the a sum of precious metal digital asset value and a precious metal inventory float value. The precious metal inventory float value operates as a buffer measure for the precious metal reserve value to efficiently meet an unexpected increased demand for precious metal digital assets. If at 414, it is determined that the precious metal reserve value (PMRV) is less than the sum of the precious metal digital asset value and a precious metal inventory float value, then at step 418 the PM reserve rebalancing module generates a fourth transaction signal to purchase precious metal in order to increase the precious metal reserve value to cover for the precious metal digital asset value and the precious metal inventory float value. The fourth transaction signal may be sent to the PM commodity trading module 172 to execute one or more trades to fulfil perform a transaction based on the fourth transaction signal.

At step 416, the PM reserve rebalancing module 118 determines whether the precious metal reserve value is sufficient to cover a sum of the precious metal digital asset value, the precious metal inventory float value and the precious metal digital asset change projection (DACP). If the precious metal reserve value exceeds the sum, then the PM reserve rebalancing module 118 generates a fifth transaction signal at 420 to sell the excess precious metal reserve value. The fifth transaction signal may be sent to the PM commodity trading module 172 to execute one or more trades to fulfil or perform a transaction based on the fifth transaction signal.

If at step 412, it is determined that the precious metal digital asset change projection (DACP) is less than the third threshold, then at step 422, the reserve rebalancing module determines whether the precious metal digital asset change projection (DACP) is less than the fourth threshold. If the precious metal digital asset change projection (DACP) is less than the fourth threshold, then at step 424, the PM reserve rebalancing module 118 determines whether there is any excess precious metal reserve inventory over and above the precious metal inventory float value and the precious metal digital asset value. If excess precious metal reserve inventory is identified at 424, then at step 428, the PM reserve rebalancing module 118 generates a sixth transaction signal to sell the excess PM reserve inventory. The sixth transaction signal may be sent to the PM commodity trading module 172 to execute one or more trades to fulfil perform a transaction based on the sixth transaction signal.

If at step 424, no excess PM reserve inventory is identified, then at step 426, the PM reserve rebalancing module 118 determines if the PM reserve inventory is insufficient to cover the PM digital assets, the PM inventory float value and the digital asset change projection (DACP). If the PM reserve inventory is determined to be insufficient, then at step 430 the PM reserve rebalancing module 430 generates a seventh transaction signal to buy addition PM reserves to compensate for the determined insufficiency.

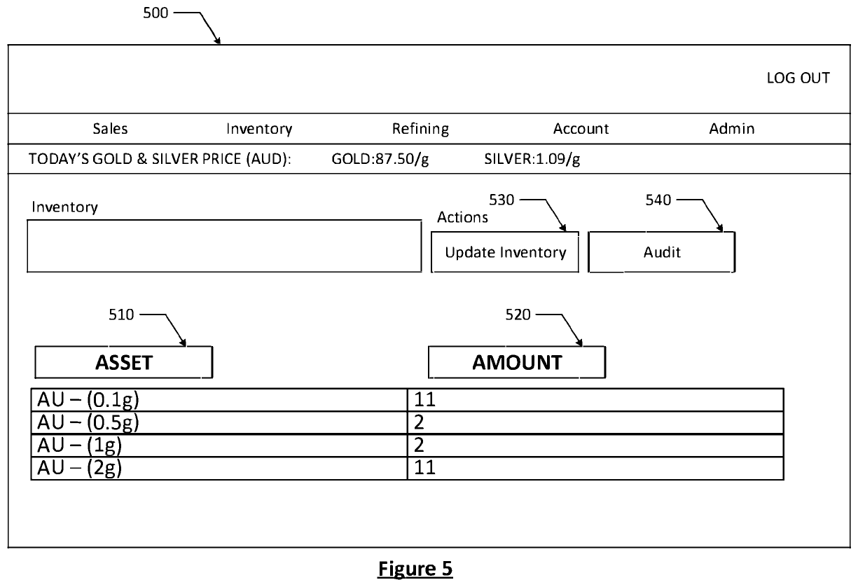

FIG. 5 illustrates a screenshot of a user interface 500 of a retail inventory management application 146 according to some embodiments. The retail inventory management application 146 allows operators at a retail outlet to manage information regarding the PM retail inventory 222. Section 510 of the user interface lists the precious metal asset types in terms in the weight of each unit of the precious metal asset. Section 520 of the user interface lists the number of units of each asset type in the PM retail inventory 222. By clicking on button 530, a user may update the PM retail inventory 222 in response to a sale of an inventory item or a receipt of an inventory item. By clicking on button 540, a user may initiate an audit of the PM retail inventory 222 at a predefined auditing schedule, for example at the beginning of trade, or at the end of trade or before and after a change of shifts in the retail outlet. The auditing process involves confirming that the physical PM retail inventory 222 is accurately reflected in the PM inventory database 116.

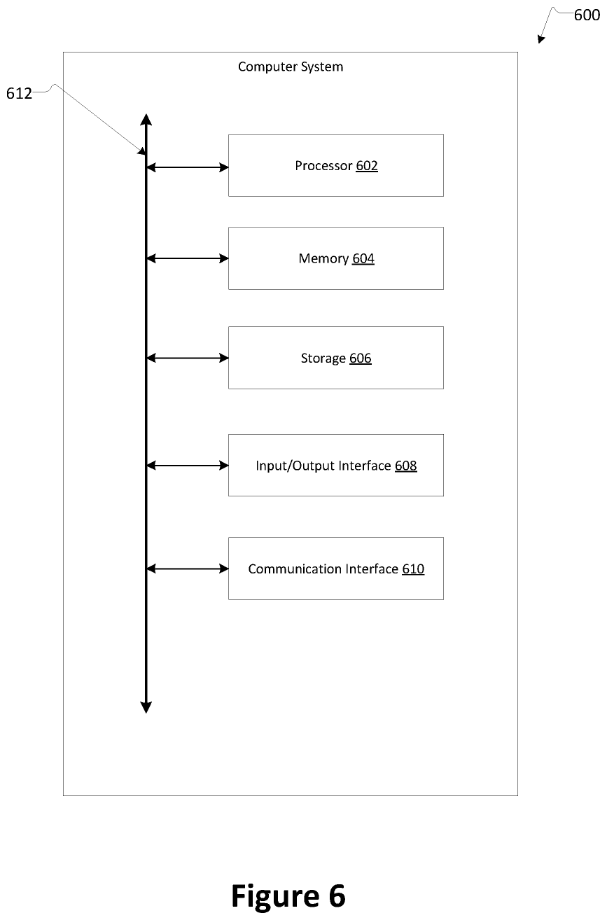

FIG. 6 illustrates an example computer system 600. In particular embodiments, one or more computer systems 600 perform one or more steps of one or more methods described or illustrated herein. In particular embodiments, one or more computer systems 600 provide functionality described or illustrated herein. In particular embodiments, software running on one or more computer systems 600 performs one or more steps of one or more methods described or illustrated herein or provides functionality described or illustrated herein. Particular embodiments include one or more portions of one or more computer systems 600. Herein, reference to a computer system may encompass a computing device, and vice versa, where appropriate. Moreover, reference to a computer system may encompass one or more computer systems, where appropriate. The precious metal reserve management server 110, vault inventory management computing device 150, precious metal assay management computing device 160, precious metal retail management computing device 140 may incorporate a subset or all of the computing components described with reference to the computer system 600 to provide the functionality described in this specification.

This disclosure contemplates any suitable number of computer systems 600 to implement each of the precious metal reserve management server 110, vault inventory management computing device 150, precious metal assay management computing device 160, and precious metal retail management computing device 140. Computer system 600 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 600 may include one or more computer systems 600; be unitary or distributed; span multiple locations; span multiple machines; span multiple data centers; or reside in a cloud, which may include one or more cloud components in one or more networks. Where appropriate, one or more computer systems 600 may perform without substantial spatial or temporal limitation one or more steps of one or more methods described or illustrated herein. As an example and not by way of limitation, one or more computer systems 600 may perform in real-time or in batch mode one or more steps of one or more methods described or illustrated herein. One or more computer systems 600 may perform at different times or at different locations one or more steps of one or more methods described or illustrated herein, where appropriate.

In particular embodiments, computer system 600 includes a processor 602, memory 604, storage 606, an input/output (I/O) interface 608, a communication interface 610, and a bus 612. Although this disclosure describes and illustrates a particular computer system having a particular number of particular components in a particular arrangement, this disclosure contemplates any suitable computer system having any suitable number of any suitable components in any suitable arrangement.

In particular embodiments, processor 602 includes hardware for executing instructions, such as those making up a computer program. As an example and not by way of limitation, to execute instructions, processor 602 may retrieve (or fetch) the instructions from an internal register, an internal cache, memory 604, or storage 606; decode and execute them; and then write one or more results to an internal register, an internal cache, memory 604, or storage 606. In particular embodiments, processor 602 may include one or more internal caches for data, instructions, or addresses. This disclosure contemplates processor 602 including any suitable number of any suitable internal caches, where appropriate. As an example and not by way of limitation, processor 602 may include one or more instruction caches, one or more data caches, and one or more translation lookaside buffers (TLBs). Instructions in the instruction caches may be copies of instructions in memory 604 or storage 606, and the instruction caches may speed up retrieval of those instructions by processor 602. Data in the data caches may be copies of data in memory 604 or storage 606 for instructions executing at processor 602 to operate on; the results of previous instructions executed at processor 602 for access by subsequent instructions executing at processor 602 or for writing to memory 604 or storage 606; or other suitable data. The data caches may speed up read or write operations by processor 602. The TLBs may speed up virtual-address translation for processor 602. In particular embodiments, processor 602 may include one or more internal registers for data, instructions, or addresses. This disclosure contemplates processor 602 including any suitable number of any suitable internal registers, where appropriate. Where appropriate, processor 602 may include one or more arithmetic logic units (ALUs); be a multi-core processor; or include one or more processors 602. Although this disclosure describes and illustrates a particular processor, this disclosure contemplates any suitable processor.

In particular embodiments, memory 604 includes main memory for storing instructions for processor 602 to execute or data for processor 602 to operate on. As an example and not by way of limitation, computer system 600 may load instructions from storage 606 or another source (such as, for example, another computer system 600) to memory 604. Processor 602 may then load the instructions from memory 604 to an internal register or internal cache. To execute the instructions, processor 602 may retrieve the instructions from the internal register or internal cache and decode them. During or after execution of the instructions, processor 602 may write one or more results (which may be intermediate or final results) to the internal register or internal cache. Processor 602 may then write one or more of those results to memory 604. In particular embodiments, processor 602 executes only instructions in one or more internal registers or internal caches or in memory 604 (as opposed to storage 606 or elsewhere) and operates only on data in one or more internal registers or internal caches or in memory 604 (as opposed to storage 606 or elsewhere). One or more memory buses (which may each include an address bus and a data bus) may couple processor 602 to memory 604. Bus 612 may include one or more memory buses, as described below. In particular embodiments, one or more memory management units (MMUs) reside between processor 602 and memory 604 and facilitate accesses to memory 604 requested by processor 602. In particular embodiments, memory 604 includes random access memory (RAM). This RAM may be volatile memory, where appropriate. Where appropriate, this RAM may be dynamic RAM (DRAM) or static RAM (SRAM).

Moreover, where appropriate, this RAM may be single-ported or multi-ported RAM. This disclosure contemplates any suitable RAM. Memory 604 may include one or more memories 604, where appropriate. Although this disclosure describes and illustrates particular memory, this disclosure contemplates any suitable memory.

In particular embodiments, storage 606 includes mass storage for data or instructions. As an example and not by way of limitation, storage 606 may include a hard disk drive (HDD), a floppy disk drive, flash memory, an optical disc, a magneto-optical disc, magnetic tape, or a Universal Serial Bus (USB) drive or a combination of two or more of these. Storage 606 may include removable or non-removable (or fixed) media, where appropriate. Storage 606 may be internal or external to computer system 600, where appropriate. In particular embodiments, storage 606 is non-volatile, solid-state memory. In particular embodiments, storage 606 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 606 taking any suitable physical form. Storage 606 may include one or more storage control units facilitating communication between processor 602 and storage 606, where appropriate. Where appropriate, storage 606 may include one or more storages 606. Although this disclosure describes and illustrates particular storage, this disclosure contemplates any suitable storage.

In particular embodiments, I/O interface 608 includes hardware, software, or both, providing one or more interfaces for communication between computer system 600 and one or more I/O devices. Computer system 600 may include one or more of these I/O devices, where appropriate. One or more of these I/O devices may enable communication between a person and computer system 600. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 608 for them. Where appropriate, I/O interface 608 may include one or more device or software drivers enabling processor 602 to drive one or more of these I/O devices. I/O interface 608 may include one or more I/O interfaces 608, where appropriate. Although this disclosure describes and illustrates a particular I/O interface, this disclosure contemplates any suitable I/O interface.

In particular embodiments, communication interface 610 includes hardware, software, or both providing one or more interfaces for communication (such as, for example, packet-based communication) between computer system 600 and one or more other computer systems 600 or one or more networks. As an example and not by way of limitation, communication interface 610 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 610 for it. As an example and not by way of limitation, computer system 600 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 600 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 1600 may include any suitable communication interface 610 for any of these networks, where appropriate. Communication interface 610 may include one or more communication interfaces 610, where appropriate. Although this disclosure describes and illustrates a particular communication interface, this disclosure contemplates any suitable communication interface.

In particular embodiments, bus 612 includes hardware, software, or both coupling components of computer system 600 to each other. As an example and not by way of limitation, bus 612 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 612 may include one or more buses 612, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A method for precious metal reserve management in a precious metal digital asset trading network implemented by a precious metal reserve management server, the method comprising:
determining by the reserve management server a total digital precious metal value corresponding to issued precious metal digital assets in the precious metal digital asset trading network;
determining by the reserve management server, a total reserve precious metal value based on reserve precious metal inventory data, wherein the precious metal inventory data relates to precious metal inventory stored in one or more physical locations;
generating by the reserve management server, a first transaction signal to purchase precious metal in response to the total reserve precious metal value being less than the total digital precious metal value;
analysing by the reserve management server, precious metal commodity pricing data to determine a commodity pricing change projection over a subsequent precious metal reserve rebalancing period, in response to the total reserve precious metal value being greater than or equal to the total digital precious metal value;
generating by the reserve management server, a second transaction signal to hold existing precious metal reserve inventory or purchase additional precious metal reserve inventory, in response to the determined commodity pricing change projection being greater than a first commodity pricing change threshold;
generating by the reserve management server, a third transaction signal to hold existing precious metal reserve inventory or sell a part of precious metal reserve inventory, in response to the determined commodity pricing change projection being less than a second commodity pricing change threshold;
determining by the reserve management server a precious metal digital asset transaction trend based on a precious metal digital asset transaction data in response to the commodity pricing change projection being less than the first commodity pricing change threshold and greater than second commodity pricing change threshold; and
generating by the reserve management server a further transaction signal based on the precious metal digital asset transaction trend and a precious metal inventory float value;
wherein the precious metal reserve management method is performed at a defined rebalancing frequency.

2. The method of claim 1, wherein determining the commodity pricing change projection comprises determining one or more repeating commodity price movement patterns based on the precious metal commodity pricing data.

3. The method of claim 2, wherein determining the commodity pricing change projection further comprises analysing a subset of the precious metal commodity pricing data to determine a fit probability of the one or more repeating commodity price movement patterns.

4. The method of any one of claims 1 to 3, wherein determining the commodity pricing change projection comprises determining a market movement pressure metric based on precious metal buy and sell order data comprised in the precious metal commodity pricing data.

5. The method of any one of claims 1 to 4, wherein determining by the reserve management server the precious metal digital asset transaction trend comprises determining an average precious metal digital asset transaction level over one or more recent transaction periods based on the precious metal digital asset transaction data.

6. The method of claim 5, wherein determining the average precious metal digital asset transaction level comprises excluding from the precious metal digital asset transaction data transactions larger than an outlier transaction threshold.

7. The method of any one of claims 1 to 4, wherein determining by the reserve management server the precious metal digital asset transaction trend comprises analysing one or more precious metal digital asset transaction data relating to unsettled precious metal digital asset transactions.

8. The method of any one of claims 1 to 7, wherein the precious metal reserve management server is configured to update the defined rebalancing frequency based on a difference between the commodity pricing change projection and an actual commodity price change over one or more previous rebalancing periods.

9. The method of any one of claims 1 to 7, wherein the precious metal reserve management server is configured to update the defined rebalancing frequency based on the precious metal digital asset transaction trend and precious metal digital asset transaction data stored for one or more previous rebalancing periods.

10. The method of any one of claims 1 to 9, wherein generating by the reserve management server the further transaction signal comprises:
generating by the reserve management server, a fourth transaction signal to purchase precious metal in response to:
the precious metal digital asset transaction trend being greater than a third threshold; and
the total reserve precious metal value being less than a sum of precious metal inventory float value and total digital precious metal value.

11. The method of any one of claims 1 to 9, wherein generating by the reserve management server the further transaction signal based on the precious metal digital asset transaction trend and a precious metal inventory float value comprises:
determining a projected change value in the total digital precious metal value based on the determined precious metal digital asset transaction trend;
generating by the reserve management server, a fifth transaction signal to sell precious metal in response to:
the precious metal digital asset transaction trend being greater than a third threshold; and
the total reserve precious metal value being greater than a sum of the precious metal inventory float value and the total digital precious metal value and the projected change value.

12. The method of any one of claims 1 to 9, wherein generating by the reserve management server the further transaction signal based on the precious metal digital asset transaction trend and a precious metal inventory float value comprises:
generating by the reserve management server, a sixth transaction signal to sell precious metal in response to:
the precious metal digital asset transaction trend being less than the third threshold and greater than a fourth threshold; and
the total reserve precious metal value being greater than a sum of precious metal inventory float value and total digital precious metal value.

13. The method of any one of claims 1 to 9, wherein generating by the reserve management server the further transaction signal based on the precious metal digital asset transaction trend and a precious metal inventory float value comprises:
determining a projected change value in the total digital precious metal value based on the determined precious metal digital asset transaction trend;
generating by the reserve management server, a seventh transaction signal to hold precious metal in response to:
the precious metal digital asset transaction trend being smaller than the third threshold and smaller than a fourth threshold; and
the total reserve precious metal value being less than a sum of the precious metal inventory float value and the total digital precious metal value and the projected change value.

14. A method for precious metal reserve management in a precious metal digital asset trading network implemented by a precious metal reserve management server, the method comprising:
determining by the reserve management server a total digital precious metal value corresponding to issued precious metal digital assets in the precious metal digital asset trading network;
determining by the reserve management server, a total reserve precious metal value based on reserve precious metal inventory data, wherein the reserve precious metal inventory data relates to precious metal inventory stored in one or more physical locations;
determining by the reserve management server a precious metal digital asset transaction trend based on a precious metal digital asset transaction data;
generating by the reserve management server, a first transaction signal to purchase precious metal in response to:
the precious metal digital asset transaction trend being greater than a first threshold; and
the total reserve precious metal value being less than a sum of a precious metal inventory float value and total digital precious metal value.

15. The method of claim 14 further comprising:
determining a projected change value in the total digital precious metal value based on the determined precious metal digital asset transaction trend;
generating by the reserve management server, a second transaction signal to sell precious metal in response to:
the precious metal digital asset transaction trend being greater than the first threshold; and
the total reserve precious metal value being greater than a sum of the precious metal inventory float value and the total digital precious metal value and the projected change value.

16. The method of claim 14 further comprising:
generating by the reserve management server, a third transaction signal to sell precious metal in response to:
the precious metal digital asset transaction trend being less than the first threshold and greater than a second threshold; and
the total reserve precious metal value being greater than a sum of precious metal inventory float value and total digital precious metal value.

17. The method of claim 14 further comprising:
determining a projected change value in the total digital precious metal value based on the determined precious metal digital asset transaction trend;
generating by the reserve management server, a fourth transaction signal to hold precious metal in response to:
the precious metal digital asset transaction trend being less than the first threshold and less than a second threshold; and
the total reserve precious metal value being less than a sum of the precious metal inventory float value and the total digital precious metal value and the projected change value.

18. A system for precious metal reserve management in a precious metal digital asset trading network, the system comprising:
at least one processor,
a memory accessible to the at least one processor, the memory comprising program code which when executed by the at least one processor configures the at least one processor to:
determine a total digital precious metal value corresponding to issued precious metal digital assets in the precious metal digital asset trading network;
determine a total reserve precious metal value based on reserve precious metal inventory data, wherein the precious metal inventory data relates to precious metal inventory stored in one or more physical locations;
generate a first transaction signal to purchase precious metal in response to the total reserve precious metal value being less than the total digital precious metal value;
analyse precious metal commodity pricing data to determine a commodity pricing change projection over a subsequent precious metal reserve rebalancing period, in response to the total reserve precious metal value being greater than or equal to the total digital precious metal value;
generate a second transaction signal to hold existing precious metal reserve inventory or purchase additional precious metal reserve inventory, in response to the determined commodity pricing change projection being greater than a first commodity pricing change threshold;
generate a third transaction signal to hold existing precious metal reserve inventory or sell a part of precious metal reserve inventory, in response to the determined commodity pricing change projection being less than a second commodity pricing change threshold;
determine a precious metal digital asset transaction trend based on a precious metal digital asset transaction data in response to the commodity pricing change projection being less than the first commodity pricing change threshold and greater than second commodity pricing change threshold; and
generate a further transaction signal based on the precious metal digital asset transaction trend and a precious metal inventory float value;
wherein the precious metal reserve management is performed at a defined rebalancing frequency.

19. The system of claim 18, wherein determining the commodity pricing change projection comprises determining one or more repeating commodity price movement patterns based on the precious metal commodity pricing data.

20. The system of claim 19, wherein determining the commodity pricing change projection further comprises analysing a subset of the precious metal commodity pricing data to determine a fit probability of the one or more repeating commodity price movement patterns.

21. The system of any one of claims 18 to 20, wherein determining the commodity pricing change projection comprises determining a market movement pressure metric based on precious metal buy and sell order data comprised in the precious metal commodity pricing data.

22. The system of any one of claims 18 to 21, wherein determining the precious metal digital asset transaction trend comprises determining an average precious metal digital asset transaction level over one or more recent transaction periods based on the precious metal digital asset transaction data.

23. The system of claim 22, wherein determining the average precious metal digital asset transaction level comprises excluding from the precious metal digital asset transaction data transactions larger than an outlier transaction threshold.

24. The system of any one of claims 19 to 23, wherein the precious metal digital asset transaction trend comprises analysing one or more precious metal digital asset transaction data relating to unsettled precious metal digital asset transactions.

25. The system of any one of claims 18 to 24, wherein the at least one processor is further configured to update the defined rebalancing frequency based on a difference between the commodity pricing change projection and an actual commodity price change over one or more previous rebalancing periods.

26. The system of any one of claims 18 to 25, wherein the at least one processor is further configured to update the defined rebalancing frequency based on the precious metal digital asset transaction trend and an precious metal digital asset transaction data stored for one or more previous rebalancing periods.

27. The system of any one of claims 18 to 26, wherein generating the further transaction signal comprises:
generating by the at least one processor, a fourth transaction signal to purchase precious metal in response to:
the precious metal digital asset transaction trend being greater than a third threshold; and
the total reserve precious metal value being less than a sum of precious metal inventory float value and total digital precious metal value.

28. The system of any one of claims 18 to 26, wherein generating the further transaction signal comprises:
determining by the at least one processor, a projected change value in the total digital precious metal value based on the determined precious metal digital asset transaction trend;
generating by the at least one processor, a fifth transaction signal to sell precious metal in response to:
the precious metal digital asset transaction trend being greater than a third threshold; and
the total reserve precious metal value being greater than a sum of the precious metal inventory float value and the total digital precious metal value and the projected change value.

29. The system of any one of claims 18 to 26, wherein generating the further transaction signal comprises:
generating by the at least one processor, a sixth transaction signal to sell precious metal in response to:
the precious metal digital asset transaction trend being less than the third threshold and greater than a fourth threshold; and
the total reserve precious metal value being greater than a sum of precious metal inventory float value and total digital precious metal value.

30. The system of any one of claims 18 to 26, wherein generating the further transaction signal comprises:
determining by the at least one processor a projected change value in the total digital precious metal value based on the determined precious metal digital asset transaction trend;
generating, by the at least one processor, a seventh transaction signal to hold precious metal in response to:
the precious metal digital asset transaction trend being smaller than the third threshold and smaller than a fourth threshold; and
the total reserve precious metal value being less than a sum of the precious metal inventory float value and the total digital precious metal value and the projected change value.

31. A system for precious metal reserve management in a precious metal digital asset trading network, the system comprising:
at least one processor,
a memory accessible to the at least one processor, the memory comprising program code which when executed by the at least one processor configures the at least one processor to:
determine a total digital precious metal value corresponding to issued precious metal digital assets in the precious metal digital asset trading network;
determine a total reserve precious metal value based on reserve precious metal inventory data, wherein the reserve precious metal inventory data relates to precious metal inventory stored in one or more physical locations;
determine a precious metal digital asset transaction trend based on precious metal digital asset transaction data;
generate a first transaction signal to purchase precious metal in response to:
the precious metal digital asset transaction trend being greater than a first threshold; and
the total reserve precious metal value being less than a sum of a precious metal inventory float value and total digital precious metal value.

32. The system of claim 31, wherein the program code when executed by the at least one processor further configures the at least one processor to:
determine a projected change value in the total digital precious metal value based on the determined precious metal digital asset transaction trend;
generate by the reserve management server, a second transaction signal to sell precious metal in response to:
the precious metal digital asset transaction trend being greater than the first threshold; and
the total reserve precious metal value being greater than a sum of the precious metal inventory float value and the total digital precious metal value and the projected change value.

33. The system of claim 31 or claim 32, wherein the program code when executed by the at least one processor further configures the at least one processor to:
generate a third transaction signal to sell precious metal in response to:
the precious metal digital asset transaction trend being less than the first threshold and greater than a second threshold; and
the total reserve precious metal value being greater than a sum of precious metal inventory float value and total digital precious metal value.

34. The system of any one of claims 31 to 33, wherein the program code when executed by the at least one processor further configures the at least one processor to:
determine a projected change value in the total digital precious metal value based on the determined precious metal digital asset transaction trend;
generate a fourth transaction signal to hold precious metal in response to:
the precious metal digital asset transaction trend being less than the first threshold and less than a second threshold; and
the total reserve precious metal value being less than a sum of the precious metal inventory float value and the total digital precious metal value and the projected change value.

35. A computer readable storage media comprising computer-readable instructions that when executed by the one or more processing units performs the method of any one of claims 1 to 17.
